(19) United States
(12) Patent Application Publication
(10) Pub. No.: US 2026/0180685 A1
(43) Pub. Date: Jun. 25, 2026

(54) METHODS AND APPARATUS FOR HIGH CAPACITY SPECTRALLY EFFICIENT MIMO AND OPTICAL BEAMFORMING ENABLED PHOTONIC MILLIMETER-WAVE OVER FIBER (MMWOF) WIRELESS TRANSCEIVER SYSTEMS BASED ON QUANTUM DOT MULTI-WAVELENGTH LASERS WITH WAVELENGTH DIVISION MULTIPLEXING AND SPACE DIVISION MULTIPLEXING

(71) Applicant: National Research Council of Canada, Ottawa (CA)

(72) Inventors: Khan ZEB, Gatineau (CA); Zhenguo LU, Ottawa (CA); Jiaren LIU, Ottawa (CA); John Xiupu ZHANG, Pierrefonds (CA)

(21) Appl. No.: 19/124,716

(22) PCT Filed: Oct. 26, 2023
(86) PCT No.: PCT/CA2023/051431

§ 371 Date: Apr. 25, 2025

Related U.S. Application Data
(60) Provisional application No. 63/419,899, filed on Oct. 27, 2022.

(51) Int. Cl. H04B 10/50; H04B 10/40; H04J 14/02

(52) U.S. Cl. CPC H04B 10/50; H04B 10/40; H04B 10/505; H04J 14/0227

(57) ABSTRACT

A method for MMW wireless communications, comprising the steps of: at a central office, with a QD MWL source, generating at least one optical signal comprising a plurality of different frequency signals; splitting the at least one optical signal into at least one first split signal and at least one second split signal; modulating the at least one first split signal with at least one wireless data signal and generating at least one downlink optical data signal, wherein the at least one frequency signal of the first split optical signal of the QD-MWL is used as an optical local oscillator (LO) for synthesizing RF MMW wireless signals remotely by mixing with the at least one downlink optical data signal; and the at least second split signal of the QD-MWL is used as an optical LO for the receiving uplink wireless signals at the central office.

### FIELD

Aspects of the disclosure relate to wireless networks and in particular to millimeter wave wireless communication networks employing radio-over-fiber.

### BACKGROUND

There is increasing demand for broadband ultrahigh speed wireless connectivity with low latency and reliability, however the sub-6 GHz spectrum is almost depleted, and therefore 5G and beyond wireless networks will need to adopt heterogeneous higher frequency carriers from the abundant spectrum in the millimeter-wave (MMW) range (30 to 300 GHz) i.e., the ultra-high frequency band. Thus by using these higher frequency bands, 5G and beyond wireless networks promise to achieve ultrahigh speed and extremely large capacity, very low latency, and better coverage with wideband operation for wireless applications. This is complemented by the massive multiple input multiple output (M-MIMO) technology, which can significantly increase the data throughput through spatial multiplexing and improve coverage and system reliability through spatial diversity, and beamforming technology that can help in mitigating losses, improving signal quality and eliminating undesirable interferences by directing a number of independent MMW wireless beams to specific locations/users. However, the generation and distribution of such ultra-high frequency broad bandwidth signals with traditional methods is limited by the electronic bottleneck and associated complexity and cost. In addition, these high frequency signals are highly susceptible to propagation path loss. Consequently, broad bandwidth, simple, efficient, and cost-effective photonic MMW-over-Fiber (MMWoF) solutions are considered viable alternatives for MMW signal generation, processing, control and distribution in the optical domain for application in broadband wireless access networks [1], [2]. The optical devices and techniques that are used for MMW signals in conjunction with the bandwidth efficient radio over fiber (RoF) technology not only overcome the problem of high bandwidth requirements, transmission capacity and span limitation but also significantly reduces system complexity [2]-[5], footprint, capital expenditure (CAPEX) and operating expenses (OPEX). Different techniques and systems based on optical heterodyne have been proposed and demonstrated for the high frequency MMW signals generation and distribution in MMWoF links based on schemes such as using two individual single wavelength lasers [6], external modulation of a single mode laser [7], [8], picking pairs of modes from optical frequency combs [9]-[12] and dual-wavelength optical sources [13]-[16]. Recently quantum dot/dash multi-wavelength lasers (QD-MWLs) spanning C- and L-bands with channel spacing that can cover an RF frequency range from tens of GHz to THz [12], [15]-[30] offer great potential as an efficient optical MMW sources for photonic MMWoF systems. These devices offer spectrally pure broadband multiple highly correlated and low noise optical channels with ultra-narrow optical spectral linewidth, very low relative intensity noise (RIN) and ultra-low timing jitters [12], [19], [24], [30], [31]. Moreover, for further spectral purity and phase stabilization in such highly integrated and correlated devices, a simple feedback mechanism of self-injection locking can be used [17], [18], eliminating the need for comparatively more complex and expensive components, thus making them a suitable candidate as an optical MMW source for 5G and beyond MMWoF wireless systems.

Moreover, efforts have been made to boost the capacity and performance of the RoF communications systems and to overcome the expected rise in the bandwidth requirements, especially in the fronthaul optical links for RoF transmissions by incorporating space division multiplexing (SDM) technologies, such as mode division multiplexing (MDM) and multicore fiber (MCF). In the former case, different light propagation paths, also called spatial modes, such as linearly polarized (LP) modes in a single core of few mode fiber (FMF) [32]-[39] or multimode fiber (MMF) [40]-[46] and orbital angular momentum (OAM) spatial modes in RCF [47] and free space optical links [48] are used for simultaneous transmission of multiple RF signals. In addition, linearly polarized vector (LPV) modes in polarization-maintaining elliptical ring core fiber (PM-ERCF) [49], [50] are used for transporting the RF signals. On the other hand, in the latter case, different cores in the same cladding of MCF are used for concurrent transmission of various RF signals using a single or multiple optical wavelengths and electrical frequencies [51]-[63]. The transmissions capacity of RoF links and in particular of 5G and beyond fronthaul networks can significantly be increased by leveraging additional multiplexing techniques such as WDM and polarization multiplexing (PolM) [64].

### SUMMARY

In one of its aspects, a method for millimeter-wave (MMW) wireless communications, the method comprising the steps of:
at a central office,
with a single quantum dot multi-wavelength laser (QD MWL) source, generating at least one optical signal comprising a plurality of different frequency signals;
splitting the at least one optical signal into at least one first split signal and at least one second split signal;
modulating the at least one first split signal with at least one wireless data signal by at least one optical modulator and generating at least one downlink optical data signal, wherein at least one of the plurality of optical signals of the first split signal is used as an optical local oscillator (LO) for synthesizing RF MMW wireless signals remotely by mixing with the at least one downlink optical data signal; and
transmitting the at least one downlink optical data signal and the optical LO over an optical transmission medium to at least one remote radio head or remote radio unit (RRH/RRU);
the at least second split signal of the QD-MWL is used as an optical LO for the receiving uplink wireless signals at the central office.

In another of its aspects, a millimeter-wave (MMW) wireless communication system comprising:
a central office comprising a single QD MWL source for generating MMW signals remotely;
an optical coupler for splitting at least one optical signal into at least one first split signal for use as at least one data channel and at least one optical LO;
a first optical modulator for modulating the least one first split signal with at least one wireless data signal and generating at least one downlink data signal;
an optical transmission medium; and
at least one remote radio head or remote radio unit (RRH/RRU) for receiving at least one downlink wireless data signal, and at least one optical LO signal for up-converting the received at least one downlink RF data signal into at least one RF MMW signal;
wherein the same at least one optical LO is reused to provide at least one optical carrier to at least one uplink MMW signal at the at least one RRH/RRU where the at least one uplink MMW signal modulates the at least one optical carrier in a single sideband (SSB) or carrier-suppressed single-sideband modulation (CS-SSB) configuration, and whereby the at least one uplink MMW signal is transmitted via the optical transmission medium to the central office, achieving RF synthesizer RRH/RRU; and
wherein the at least one RF MMW signal received at the central office is optically down-converted to at least one intermediate frequency (IF) or baseband signal by the at least one optical channel of the same QD-MWL or down-converted electronically depending on the system requirements and the at least one IF/baseband signal is converted to digital signal for baseband digital signal processing.

Advantageously, the MMWoF transport solution with space division multiplexing (SDM) and wavelength division multiplexing (WDM) technologies and photonic MMW signals generation and distribution in the optical domain and with M-MIMO and optical beamforming (OBF) capabilities based on quantum dot (QD) multi-wavelength lasers (MWLs) can efficiently achieve the long-reach, high bandwidth, high speed, high centralization, high energy efficiency, and low latency and cost-effectiveness requirements of 5G and beyond MMW wireless communication networks.

The methods and systems provide seamless fiber-wireless integration (optical fiber and RF integration) in the form of RoF with photonic MMW signals generation and distribution in the optical domain using low noise highly coherent, correlated and integrated QD-MWL optical sources with flat spectra comprising of multiple equally spaced optical channels. The optical fiber's inherent characteristics of high bandwidth, low loss, and immunity to electromagnetic interference allow for these high frequency and ultra-broadband MMW wireless signals to be distributed efficiently to long distances. Thus, this integration not only overcomes the problem of high bandwidth requirement, transmission capacity and span limitation of these high frequency signals, but at the same time, it can significantly reduce the system cost and complexity by eliminating expensive RF components such as ADCs/DACs and electrical local oscillators, especially in the case of 5G ultra-dense networks with small cells in centralized cloud radio access network (C-RAN) configuration where large number of RRHs/RRUs with M-MIMO will be deployed. In addition, fiber-wireless integration for antenna remoting through photonic MMW signals generation with M-MIMO phased array antennas (PAAs) also facilitates remote analog optical beamforming, which is used to overcome the high propagation loss of MMW signals in the wireless channel. Compared with the conventional electrical beamforming where a dedicated RF chain or phase/amplitude control is required for each radiating antenna element that adds up to the size, complexity and hardware cost in addition to bandwidth limitations, electromagnetic interference and high power consumption, optical beamforming (OBF) with higher available bandwidth can significantly reduce the complexity, cost and power consumption using photonic true time delay lines (TTDLs). The OBF with photonic TTDLs can also help in alleviating the problem of beam squint in wide-band applications. Since in the case of OBF with TTDLs, the beam pointing direction is a function of the optical delay line where all frequency components have the same delay times, whereas in the case of beamforming with electrical phase shifters, it is dependent on the signal frequency leading to beam squint in wide-bandwidth applications. Moreover, the existing fronthaul links between the RRHs/RRUs and baseband units (BBUs) are based on digital RoF (D-RoF) with a common public radio interface (CPRI) as the main interface protocol, which poses major challenges in terms of extremely high capacity requirements for 5G and beyond wireless networks. Therefore, analog RoF (A-RoF) fronthaul is considered as an alternative to CPRI based D-RoF for 5G and beyond C-RAN due to its bandwidth efficiency, low latency, and cost-effectiveness, [64]-[68]. The bandwidth efficiency in analog mobile fronthaul is achieved by transmitting multiple RF signals simultaneously in analog form without digitization requirements as in the case of CPRI based D-RoF interface. However, analog RoF transmission of high frequency MMW signals is susceptible to various transmission impairments.

The present methods and systems provide photonic MMW signals generation and distribution methods along with OBF capability for M-MIMO MMWoF systems of 5G and beyond wireless communication networks. Furthermore, considering the cell densification with large number of antennas remoting, M-MIMO and beamforming technology and the use of MMW spectrum, the required bandwidth in RoF links in particular fronthaul links would scale up to an extent that would exceed the huge bandwidth provided by the single optical fiber link. Therefore, this expected rise in the bandwidth requirements of optical links calls for novel multiplexing dimensions of space division multiplexing (SDM) such as mode division multiplexing (MDM) in few mode fiber (FMF) in the form of linearly polarized (LP) modes, ring core fiber (RCF) in the form of orbital angular momentum (OAM) modes and multicore fiber (MCF) tailored with wavelength division multiplexing (WDM) and polarization multiplexing (Pol-Mux). Thus, these novel MMWoF transport solution with SDM and WDM technologies and photonic MMW signals generation and distribution in the optical domain can efficiently achieve the high bandwidth, high speed, high centralization, high energy efficiency, and low latency and cost-effectiveness requirements of 5G and beyond wireless communication networks. For instance, the present invention may be employed in 5G fixed wireless access (FWA) networks, which aim at providing fiber-like connectivity, for realizing ultra-high speed high capacity spectrally efficient M-MIMO and OBF enabled photonics MMW RoF wireless transceiver systems.

There is provided a method wherein the step of multiplexing comprises at least one of wavelength division multiplexing (WDM) and/or space division multiplexing (SDM) where plurality of optical frequency individual or WDM multiplexed signals are transmitted in at least one of a plurality of spatial modes of the optical SDM link in both directions. The plurality of optical signals are then used to generate RF MMW SISO or M-MIMO, or OBF signals or combination of them at the RRHs/RRUs in various frequency bands with single or multi-beam operation depending on network requirements for wireless transmission to one or more users. For optical beamforming in the transmission and receiving end, remote optical beamforming control through optical beamforming network (OBFN) is implemented to adjust the relative amplitude and time delays or phase of the transmitted and received signals from the radiating antenna elements of a phased array antenna (PAA) for the intended shape and direction of the wireless beam.

Furthermore, these system designs are flexible and scalable for achieving high capacity, high speed, and low latency photonic MMWoF wireless links as compared with the current conventional technology, thus these systems designs not only increases the capacity but also reduces the cost and complexity.

### BRIEF DESCRIPTION OF THE DRAWINGS

Several exemplary embodiments of the present disclosure will now be described, by way of example only, with reference to the appended drawings in which:

FIG. 1 shows an overview of a photonic millimeter-wave-over-Fiber (MMWoF) wireless system with SISO, MIMO and OBF scenarios;

FIG. 2 shows a simplified bidirectional M-MIMO and OBF enabled photonic MMWoF wireless system design based on a single QD MWL with WDM, OBFN and PAA;

FIG. 3 shows a simplified bidirectional M-MIMO and OBF enabled photonic MMWoF wireless system design based on a single QD MWL with SDM; OBFN and PAA;

FIG. 4 shows a comprehensive framework of the bidirectional M-MIMO and beamforming enabled MMWoF systems based on QD MWL with WDM into SDM; and

FIG. 5 shows an output measured optical spectrum of one of the exemplary QD MWLs having over 40 optical channels of appreciable flatness with channel spacing of around 34 GHz.

### DETAILED DESCRIPTION OF EXEMPLARY EMBODIMENTS

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

Moreover, it should be appreciated that the particular implementations shown and described herein are illustrative of the invention and are not intended to otherwise limit the scope of the present invention in any way. Indeed, for the sake of brevity, certain sub-components of the individual operating components, conventional data networking, application development and other functional aspects of the systems may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

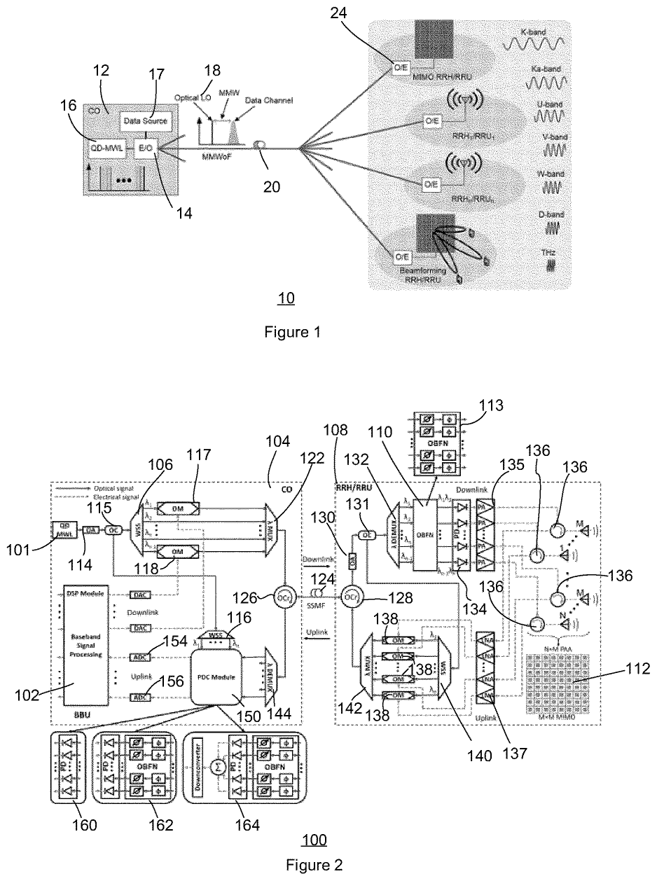

Looking at FIG. 1, there is shown a high-level overview of a MMWoF wireless system design based on QD-MWL with WDM and SDM. The system 10 comprises a central office (CO) 12 with an electrical to optical conversion system 14 comprising of optical modulators with a single QD-MWL 16 for providing a plurality of wavelength channels spaced at the desired MMW frequency signals for converting RF wireless data signals from a data source 17 on to a plurality of optical signals. The optical signals include a plurality of data channels and optical local oscillator (LO) 18 channels spaced at the desired MMW frequency from the data channels. The plurality of modulated optical signals and optical LOs may be multiplexed over a long standard single mode fiber(s) (SSFM) or spatial few/multi-mode/core or spatial modes fiber(s) 20 for transmission to remote radio heads/units (RRHs)/(RRUs) 24. The plurality of optical signals are separated by a splitter, which may be comprised of one or more multiplexers, wavelength selective switches, routers or photonic devices that can separate and/or combine optical signals, at the RRHs/RRUs and are directed over shorter fibers towards to the respective RRHs/RRUs, which may be SISO, M-MIMO, beamforming or combinations of RRHs/RRUs depending on network deployment and requirements. The corresponding optical signals are then used to generate MMW SISO or M-MIMO, or OBF signals or combination of them depending on network requirements at RRHs/RRUs for transmission to one or more user equipment (UE). The (RRH)/(RRU) 24 is comprised of an optical to electrical converter which may include optical amplifier(s) and photodetector(s) for converting the multiplexed optical signals to multiple RF frequency bands in the higher microwave and MMW spectrum, such as K-band, Ka-band, U-band, V-band, W-band, D-band, and even up to THz by selecting appropriate optical channels. This includes the standard 3GPP 5G new radios (NRs) frequency range 2 (FR 2 ) spectrum of 24.25 GHz to 71 GHz. The RRH/RRU may also include individual or phased array antenna(s) along with electrical amplifiers for achieving SISO or M-MIMO and beamforming signals. In addition, the RRH/RRU may include optical modulators for uplink electrical to optical conversion.

Accordingly, the QD MWL 16 can be used as a common optical source for different RRHs/RRUs in different cells or M-MIMO RRHs configuration with beamforming capability to provide optical LO and data channels through SDM and WDM optical transport solutions. Accordingly, a single QD MWL 16 may be employed instead of a plurality of individual laser sources in the CO 12 and RRHs/RRUs as found in the prior art systems.

Now looking at FIG. 2, there is shown a bidirectional MIMO and OBF enabled MMWoF wireless system 100 design based on QD-MWL 101 with WDM. Generally, in the base band unit (BBU) 102 associated with the central office (CO) 104, multiple coherent optical carriers (depending on the system requirements) of the QD MWL 101 are selected through wavelength selective switch (WSS) 106 for downlink data channels and an optical LO to optically generate MMW M×M MIMO signals remotely over WDM in a standard single mode fiber (SSMF). Two wavelengths λₓ and λ_{y} (where x, y=1, 2 . . . n, and x≠y) with the required MMW frequency difference are selected from the optical carriers of the QD-MWL source 101. In one example, λₓ is employed for carrying downstream data transmission channels while λ_{y} is employed for upstream signal's modulation and heterodyne MMW signal generation at the RRH/RRU 108. For transmission beamforming in the RRH/RRU 108, these channels are passed through the optical beam forming network (OBFN) 110 before beating them on an array of photodetectors to generate the corresponding MMW signals and feeding these channels to the respective radiating elements of the phased array antenna 112. The OBFN 110 may comprise of variable optical attenuators and optical true time delay lines (OTTDLs) for controlling the relative amplitudes and relative time delays of the signals that excite the antenna elements in accordance with the intended beam shape and beam direction, shown as by element 113 in FIG. 2. Thus the OBFN adjust the amplitude and time delay or phase of the signal in order to steer the beam in the desired direction. In the uplink, the optical LOs are single side band modulated 138 with or without carrier suppression by the upstream MMW signals depending on the implementation scenario. These signals are then down-converted 150 to intermediate/baseband signals at the CO by using the same QD-MWL 101. The system design of FIG. 2 can be used to realize SISO and/or M-MIMO without or with OBF configuration in various frequency bands with single or multi-beam operation with few or large number of RRHs/RRUs depending on the network requirements;

More specifically, FIG. 2 shows an exemplary implementation of a bidirectional system 100 for an exemplary 5G network. For example, in the central office 104 there is provided a single laser source, such as QD-MWL 101, for generating an optical signal comprising of a plurality of wavelengths which is amplified by an optical amplifier 114. The amplified signal is received by an optical coupler or optical splitter 115 which splits the signal into two parts, with one part destined for a downlink wavelength selective switch (WSS) 106 and another part of the signal is sent to an uplink wavelength selective switch (WSS) 116, as will be explained later. In one example, 90% of the signal is sent to the downlink wavelength selective switch (WSS) 106 and 10% of the signal is sent to the uplink wavelength selective switch (WSS) 116.

The wavelength selective switch (WSS) 106 thus provides a plurality of optical channels of differing wavelengths from which individual channels can be selected. For example, two channels, λ₁ and λ₂ may be selected based on the desired MMW frequency at the remote radio unit or remote radio head (RRU)/(RRH) 108. For example, if the desire is to generate a 60 GHz frequency signal, then λ₁ and λ₂ are selected to this frequency spacing. In one example, λ₁ is selected as a data channel and modulated with an RF data signal e.g. a 5G signal from the BBU 102 by an optical modulator (OM) 117, λ₂ is selected as an optical local oscillator signal_{.} The same process is repeated for λₙ and λₙ₋₁, in which λₙ₋₁ is selected as a data channel and modulated with an RF data signal e.g. a 5G signal from the BBU 102 by an optical modulator (OM) 118, λₙ is selected as an optical local oscillator signal. In some scenarios, for instance OBF or MIMO, a single optical modulator may be used to modulate all of the required optical channels out of λ₁ to λₙ₋₁ by a single RF data signal_{.} λ₁, λ₂, λₙ, and λₙ₋₁ are then multiplexed with other channels by a flexible grid wavelength multiplexer 122 and downlink transmitted via a standard single mode fiber (SSMF) 124 between an optical circulator 126 of the central office 104 and an optical circulator (OCr) 128 at the RRH/RRU 108. In one example, the standard single mode fiber 124 may be 10-20 km in length.

At the RRH/RRU 108, the received signal is amplified by an optical amplifier 130 and received at an optical coupler or optical splitter 131 which splits the signal into two parts, with one part of the signal destined for a flexible grid wavelength demultiplexer 132, and another part of the signal is sent to an uplink wavelength selective switch (WSS) 140, as will be explained later. In one example, 70% of the signal is sent to the demultiplexer 132 and 30% of the signal is sent to the uplink wavelength selective switch (WSS) 140.

The demultiplexer 132 separates the channels λ₁, λ_{2,} λₙ₋₁, λₙ, and then the two channels λ₁, λ₂, which were selected in the CO 104 with the 60 GHz spacing are fed into the optical beamforming network (OBFN) 110 in the case of optical beamforming operation scenario where the amplitude and time delay or phase of the signals are adjusted in accordance with the intended direction of the beam steering, and then the two channels λ₁, λ₂ are beat on an array of photo detectors 134. Next, the millimeter wave signal generated after the photodetector 134 is amplified by an array of power amplifiers (PAs) 135 before it is received by the phased array antenna 112 via front-end circulator 136 for single input single output (SISO) or M×M Multiple Input Multiple Output (MIMO) operation with beamforming and the corresponding downlink MMW signals are transmitted over the air interface for propagation, and a percentage of that optical LO signal is used to modulate the uplink transmission channels. In the case of OBF, the MMW signal beam from a N×M phased array antenna (PAA) is directed to a specific user or location. The same process is repeated for λₙ and λₙ₋₁.

For the uplink, RF MMW signals from the phased array antenna 112 or individual antennas with SISO or M×M-MIMO configuration or beamforming signals from each antenna elements are amplified by an array of low-noise amplifiers (LNAs) 137. The signal (30% of the signal, for example) from the optical coupler 131 is received by the wavelength selective switch (WSS) 140 where a plurality of channels of differing wavelengths λ_{2 . . .} λₙ, are selectable. In one example, λ₂ is selected as an optical carrier for uplink and modulated with an RF MMW data signal from the LNAs 137 using for example single sideband (SSB) or carrier-suppressed single-sideband modulation (CS-SSB) by employing optical modulator (OM) 138. The channels λ_{2 . . .} λₙ are then multiplexed together by a multiplexer 142 and uplink transmitted via the standard single mode fiber (SSMF) 124 between OCr 128 at the RRH/RRU 108 and the optical circulator 126 of the central office 104.

At the central office 104, the received signals are sent to a demultiplexer 144 which separates the channels and sends them to a photonic down-conversion (PDC) module 150, where these optical signals are mixed with the signals from WSS 116 e.g. the 10% signal from the optical coupler or optical splitter 115 to generate a lower frequency band signal(s), which is ultimately received by analog-to-digital converter (ADC) 154, 156, and the digital signal is sent to the digital signal processing (DSP) module of the BBU 102 for baseband signal processing. The PDC module 150 may have different configuration depending on the system implementation and network scenario. In one example with a simple SISO or MIMO implementation with large number of RRHs/RRUs 108, the PDC 150 may include an array of photo detectors along with other components such as couplers etc., to down-convert the received SISO or MIMO signals, as shown by element 160 in FIG. 2. In another example with OBF scenario where the received optical signals from the PAA elements 112 in the RRH/RRU 108 are passed through a received OBFN for time delay or phase and amplitude adjustments, as shown by element 162 in FIG. 2, such that the converted electrical signals are at low frequency and can be add up to construct the final receiving beam in the direction the receiving wireless signals. This signal processing operation can be performed either in analog form or in digital form by sending the corresponding electrical signals to the BBU. On the other hand, if the converted electrical wireless signals after the OBFN operation are still in the MMW frequency band, for instance if the uplink wireless signals are SSB modulated at the RRH/RRU and then detected at the CO after adjusting the time delay or phase and amplitude through OBFN, then the received wireless beam is down-converted to an IF or baseband before sending it to the BBU for DSP, as shown by element 164 in FIG. 2. This down-conversion can either be realized optically using the plurality of the QD-MWL channels or electrically by using an RF local oscillator.

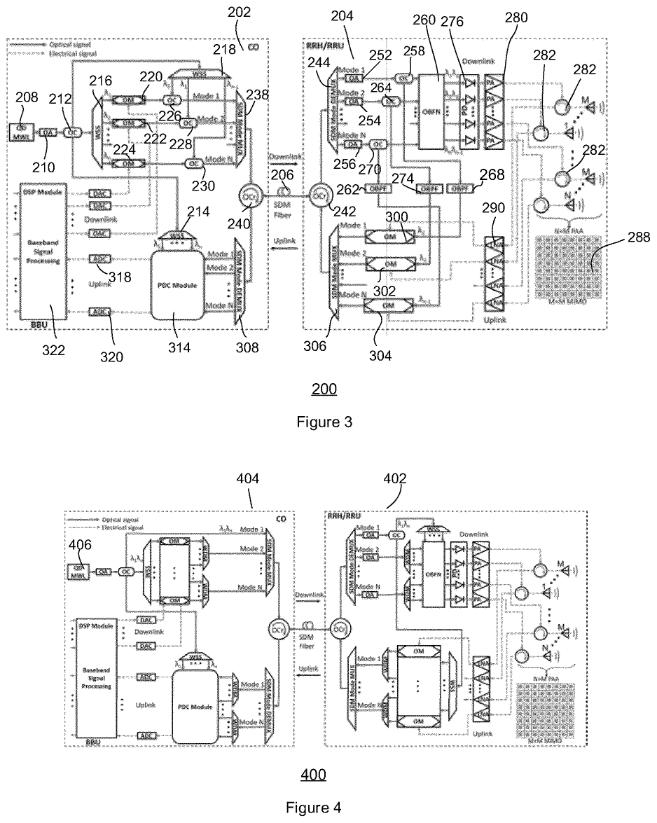

In another implementation, as shown in FIG. 3, there is shown another system 200 for photonic MMW signals generation, OBF and MIMO configuration. System 200 is similar to system 100, shown in FIG. 2, however system 200 is based on spatial division multiplexing (SDM) by employing MDM. Accordingly, system 200 is relatively more scalable and more flexible than system 100, as the plurality of same optical channels may be employed both for data channels as well as optical LO, thereby substantially increasing the spectrum efficiency and capacity. The system 200 comprises CO 202 is communicatively coupled to RRH/RRU 204 over SDM fiber 206.

In the central office 202 there is provided a single laser source, such as QD-MWL 208, for generating an optical signal comprising of a plurality of wavelengths which is amplified by an optical amplifier 210. The amplified signal is received by an optical coupler or optical splitter 212 which splits the signal into three parts, with one part destined for an uplink wavelength selective switch (WSS) 214, one part of the signal is sent to a first downlink wavelength selective switch (WSS) 216, and another part of the signal is sent to a second downlink wavelength selective switch (WSS) 218.

The wavelength selective switch (WSS) 216 provides a plurality of channels of differing wavelengths from which individual channels λ₁, λ₂ . . . λₙ can be selected. For example, two channels may be selected based on the desired MMW frequency at the remote radio unit or remote radio head 204. In one example, λ₁ is selected as a data channel and modulated with an RF data signal e.g. a 5G signal from the BBU 322 by an optical modulator (OM) 220, λ₂ is selected as another optical data channel which is modulated with an RF data signal from the BBU 322 by an optical modulator (OM) 222, and λₙ is modulated with an RF data signal from the BBU 322 by an optical modulator (OM) 224. In the case of MIMO with beamforming, a single OM may be used to modulate a plurality of optical channels with the RF data signal. Correspondingly, the second wavelength selective switch (WSS) 218 provides a plurality of optical LO channels of differing wavelengths from which individual channels λ₁, λ₂ . . . λₙ₋₁ can be selected. For example, λ₂ from the second wavelength selective switch (WSS) 218 is received by an optical coupler (OC) 226 and combined with data modulated channel λ₁ from the first wavelength selective switch (WSS) 216. λ₁ from the second wavelength selective switch (WSS) 218 is received by an optical coupler (OC) 228 and combined with another data modulated channel λ₂ from the first wavelength selective switch (WSS) 216; and λₙ₋₁ from the second wavelength selective switch (WSS) 218 is received by an optical coupler (OC) 230 and combined with data channel λₙ from the first wavelength selective switch (WSS) 216.

Next, the combined signals from OCs 226, 228, and 230, respectively, are then multiplexed by an SDM-MDM multiplexer 238 over a plurality of spatial modes. The multiplexed channels are downlink transmitted via SDM fiber 206 between an optical circulator 240 of the central office 104 and an optical circulator 242 at the RRH/RRU 204.

From the optical circulator 242 of RRH/RRU 204, the spatially multiplexed channels are received by SDM demultiplexer 244 which separates the channels, and the separated channels are amplified by optical amplifiers (OAs) 252, 254, and 256 and sent to OC 258, OC 264, and OC 270, respectively. In certain cases, to decouple the spatial modes, MIMO digital signal processing (DSP) may be required, which may be implemented in the form application specific integrated circuit (ASIC). Next, a portion of the split signal from OCs 258, 264, 270 is received by OBFN 260 in the case of optical beamforming scenario to adjust the time delay or phase and amplitude of the signals for the intended beam direction and then the corresponding pair of channels λ₁λ₂, λ₂λ_{1 . . .} λₙλₙ₋₁ are beat on an array of photo detectors 276 to generate the MMW signals for wireless propagation. The MMW signals generated after the photodetectors 276 is amplified by an array of power amplifiers (PAs) 280 and the corresponding MMW signals are sent to circulators 282, and before being received by the respective radiating elements of the phased array antenna (PAA) 288 or individual antennas for M×M MIMO or SISO operation depending on the implementation scenario and mode of operation. The other portion of the split signal from OCs 258, 264, 270 is received by optical band pass filters (OBPFs) 262, 274, 268 and the output λ₂, λ_{1, . . .} λₙ₋₁ from the OBPFs 262, 274, 268 are received by optical modulators (OMs) 300, 302, 304. These optical carriers are modulated by the uplink MMW signals in SSB or CS-SSB modulation configuration and the corresponding optical signals at different wavelengths are then spatially multiplexed on different spatial modes by SDM multiplexer 306.

For the uplink, RF MMW signals from the PPA 288, elements of M×M MIMO system are sent to circulator 282 and amplified by an array of low-noise amplifiers (LNAs) 290. At OMs 300, 302 and 304 λ₂, λ₁ and λₙ₋₁ are selected as an uplink optical carriers, respectively, for uplink transmission of the original MMW wireless signals received from PAA elements in the case of MIMO with beamforming. The selected optical channels are then SSB or CS-SSB modulated with the corresponding RF MMW data signal from the low-noise amplifiers (LNAs) 290. The modulated channels are then multiplexed together on different combination of sub-sets of spatial modes by SDM multiplexer 306 and uplink transmitted via the SDM 206 optical link between the optical circulator 242 at the RRH/RRU 204 and the optical circulator 240 of the central office 202.

At the central office 202, the received signals at the optical circulator 240 are sent to an SDM demultiplexer 308 which separates the channels. MIMO DSP may be required to separate the corresponding spatial channels. These channels are then combined with the outputs selected from the uplink wavelength selective switch (WSS) 214 in PDC module 314. The PDC module 314 beats the signals from the SDM demultiplexer 308 and WSS 214 depending on the implementation scenario to generate lower frequency band signals which are received by analog-to-digital converters (ADCs) 318, 320, respectively, and the digital signals are sent to the DSP module in the BBU 322 for signal processing. The PDC module 314 may have different configuration depending on the system implementation and network scenario as discussed earlier with reference to FIG. 2. The system design of FIG. 3 brings more flexibility and scalability in the transport network, which can be used to realize SISO and/or M-MIMO without or with OBF configuration in various frequency bands with single or multi-beam operation with few or large number of multiple RRHs/RRUs depending on the network requirements.

In another implementation, as shown in FIG. 4, there is shown another comprehensive system 400 for photonic MMW signals generation and distribution with OBF and MIMO capabilities. In system 400 the QD-MWL spectrum is used both as data channel for M×M MIMO configuration or SISO scenarios and optical LO for both up-conversion at the RRH/RRU 402 and down-conversion at the CO 404. This is achieved through WDM of a plurality of optical channels into a plurality of spatial modes of SDM (WDM-SDM) through MDM where one sub-set of a plurality of different spatial modes is used to transport the QD-MWL based WDM multiplexed data channels and a combination of another spatial mode(s) is used to transport the corresponding multiplexed (wavelength mux) optical LOs in both directions. The data and optical LO signals can also be transported together in various WDM multiplexed channels on different spatial modes of the SDM link in both direction. However, to alleviate interaction and crosstalk between the optical signals in the link, different combination of wavelengths (frequencies) and spatial modes are selected in both directions. This process can be nested into further modes by using the same laser source 406 or a different QD-MWL source depending on the network requirements. Accordingly, this makes the design tremendously flexible and scalable. Depending on system requirements, multiple optical carriers can be used for both downlink and uplink transmission with different combinations of optical frequencies and spatial modes. The principal implementation of this system and OBF of MIMO N×M-PPAs in this method are similar to those in systems 100 and 200. In this system design, various combination of optical signals from QD-MWL can be multiplexed to transport RF MMW wireless data signals in different combination of spatial modes in both directions for SISO, M-MIMO and OBF links depending on the network scenario and system requirements.

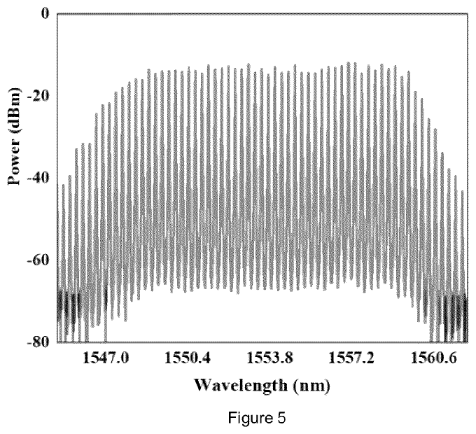

FIG. 5 shows an output measured optical spectrum of one of the exemplary QD MWLs having over 40 optical channels of appreciable flatness with the minimal channel spacing of around 34 GHz. This exemplary spectrum plot is just for the purpose of illustration of the invention and is not intended to otherwise limit the scope of the present invention in any way. QD-MWLs with different spectral ranges and channel spacing can be obtained according to the network requirements.

Accordingly, the present high capacity spectrally efficient M-MIMO and OBF enabled all-optical MMWoF systems are based on different methods for 5G and beyond wireless communication networks using QD-MWL technology. These systems employ multi-wavelength channels of QD lasers for photonic MMW signals generation/down-conversion and remote OBF control and SDM along with WDM for transporting MMW MIMO signals in the optical domain. The systems 100, 200, and 400 employ remote optical beamforming network (OBFN) based on TTDLs for M-MIMO antenna arrays configuration.

SDM and WDM technologies are employed in the present systems in order to achieve high-capacity gain in the fronthaul links. SDM may be realized through MDM using LP modes by separating multiple optical channels in a single FMF as an alternative to multiple standard SMFs. It can also be employed through OAM modes using specialized fibers, such as RCF. Moreover, SDM through MCF and FM-MCF can also be considered depending on the requirements. The MMW signals generation/distribution and down-conversion is realized through remote optical heterodyne of QD MWL at the RRHs/RRUs and central office (CO), respectively. Consequently, the corresponding MMW M×M MIMO signals are generated and distributed in the optical domain using SDM along with WDM. In addition, OBF can be performed on all of the channels by incorporating remote OBFN of TTDLs with N×M PAAs. SDM links are prone to inter-modal crosstalk due to the interaction and power leakage between the different spatial modes, especially when multiple optical signals are multiplexed onto a single SDM link, which may reduce the transmission performance, therefore, different combinations of optical signals and different sub-sets of spatial modes in both uplink and downlink directions may be used to alleviate the crosstalk. For example, one sub-set of spatial modes may be used for transporting the RF MMW signals in the downlink direction and a different second sub-set of spatial modes for transporting the signals in the uplink direction. Similarly, different combinations of the optical signals at different wavelengths (frequencies) may be employed in the uplink and downlink directions. Besides, the crosstalk may be reduced by using multiple SDM or WDM links on separate fibers where permitted. In addition, MIMO DSP may be required to decouple the spatial modes at the receiving end, which may be achieved through incorporating MIMO DSP ASICs in the system depending on the implementation and system requirements.

In one implementation, there is provided a central office transceiver and an RRH/RRU transceiver, and each of the transceivers may be integrated in a single chipset.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking and parallel processing may be advantageous.

Moreover, the separation and/or integration of various system modules and components in the implementations described above should not be understood as requiring such separation and/or integration in all implementations, and it should be understood that the described program components and systems can generally be integrated together in a single software product or packaged into multiple software products.

Accordingly, the above description of example implementations does not define or constrain this disclosure. Other changes, substitutions, and alterations are also possible without departing from the spirit and scope of this disclosure.

The benefits and advantages described above may relate to one embodiment or may relate to several embodiments. The embodiments are not limited to those that solve any or all of the stated problems or those that have any or all of the stated benefits and advantages. The operations of the methods described herein may be carried out in any suitable order, or simultaneously where appropriate. Additionally, individual blocks may be added or deleted from any of the methods without departing from the spirit and scope of the subject matter described herein. Aspects of any of the examples described above may be combined with aspects of any of the other examples described to form further examples without losing the effect sought.

### REFERENCES

[1] J. Yao, “Microwave photonics,” J. Light. Technol., vol. 27, no. 3, pp. 314-335, Feb. 2009.
[2] K. Zeb, X. Zhang and Z. G. Lu, “High Capacity Mode Division Multiplexing Based MIMO Enabled All-Optical Analog Millimeter-Wave Over Fiber Fronthaul Architecture for 5G and Beyond,” IEEE Access 7, 89522-89533, (2019).
[3] J. Yu, “Photonics-assisted millimeter-wave wireless communication, IEEE J. Quantum Electronics, vol. 53, no. 6, pp. 1-17, Dec. 2017.
[4] C. Lim and A. Nirmalathas, “Radio-over-fiber technology: present and future,” J. Lightw. Technol., vol. 39, no. 4, pp. 881-888, Feb. 2021, doi: 10.1109/JLT.2020.3024916.
[5] A. Delmade, C. Browning, T. Verolet, J. Poette, A. Farhang, H. H. Elwan, R. D. Koilpillai, G. Aubin, F. Lelarge, A. Ramdane, D. Venkitesh, and L. P Barry, “Optical heterodyne analog radio-over-fiber link for millimeter-wave wireless systems,” J. Light. Technol., vol. 39, no. 2, pp. 465-474, Jan. 2021.
[6] X. Li, J. Yu, L. Zhao, K. Wang, C. Wang, M. Zhao, W. Zhou, and J. Xiao, “1-Tb/s Millimeter-Wave Signal Wireless Delivery at D-Band,” J. Light. Technol., vol. 37, no. 1, pp. 196-204, Jan. 2019.
[7] J. L. Li, F. Zhao, and J. Yu, “D-band millimeter wave generation and transmission though radio-over-fiber system,” IEEE Photonics J. vol. 12, no.2, pp.1-8, Apr. 2020.
[8] X. Pan, X. Liu, H. Zhang, C. Wang, X. Wang, Y. Zhang, and D. Ran, “Photonic vector mm-wave signal generation by optical dual-SSB modulation and a single push-pull MZM,” Opt. Lett., vol. 44, no. 14, pp. pp. 3570-3573, Jul. 2019.
[9] C. Browning, H.H. Elwan, E.P. Martin, S. O'Duill, J. Poette, P. Sheridan, A. Farhang, B. Cabon, and L.P. Barry, “Gain-switched optical frequency combs for future mobile radio-over-fiber millimeter-wave systems,” J. Lightw. Technol., vol. 36, no. 19, pp. 4602-4610, Oct. 2018.
[10] G. K. M. Hasanuzzaman, H. Shams, C. C. Renaud, J. Mitchell, A. J. Seeds, and S. Iezekiel, “Tuneable-fiber link based on an optoelectronic oscillator-driven optical comb,” J. Lightw. Technol., vol. 38, no. 19, pp. 5240-5147, Oct. 2020.
[11] G. K. M. Hasanuzzaman, A. Kanno, P.T. Dat, and S. Iezekiel, “Self-oscillating optical frequency comb: application to low phase noise millimeter wave generation and radio-over-fiber link,” J. Lightw. Technol., vol. 36, no. 19, pp. 4535-4542, Oct. 2018.
[12] K. Zeb, Z. G. Lu, J. R. Liu, Y. X. Mao, G. Liu, P. J. Poole, M. Rahim, G. Pakulski, P. Barrios, W. H. Jiang, and X. Zhang, “InAs/InP quantum dash buried heterostructure mode locked laser for high capacity fiber-wireless integrated 5G new radio fronthaul systems,” Opt. Express, vol. 29, no. 11, pp. 16164-16174, 2021.
[13] G. Carpintero, K. Balakier, Z. Yang, R. C. Guzman, A. Corradi, A. Jimenez, G. Kervella, M. J. Fice, M. Lamponi, M. Chitoui, F. van Dijk, C. C. Renaud, A. Wonfor, E. A. J. M. Bente, R.V. Penty, I. H. White, and A.J. Seeds, “Microwave photonic integrated circuits for millimeter-wave wireless communications,” J. Technol., vol. 32, no. 20, pp. 3495-3501, Oct. 2014.
[14] S.E. Alavi, M. R. K. Soltanian, I. S. Amiri, A.S. M. Supa'at, and H. Ahmad, “Towards 5G: A Photonic Based Millimeter Wave Signal Generation for Applying in 5G Access Fronthaul,” Sci. Rep. vol. 6, no. 1, pp. 19891, 2016.
[15] K. Zeb, Z.G. Lu, J.R. Liu, Y.X. Mao, G. Liu, P. J. Poole, M. Rahim, G. Pakulski, P. Barrios, M. Vachon, D. Poitras, W.H. Jiang, J. Weber, X. Zhang, and J. Yao, “Broadband optical heterodyne millimeter wave-over-fiber wireless links based on a quantum dash dual wavelength DFB laser,” J. Lightwave Technology, Vol. 40, no. 12, pp. 3698-3708, Feb. 2022.
[16] K. Zeb, Z. G. Lu, J. R. Liu, Y. X. Mao, M. Rahim, P. J. Poole, P. Barrios, G. Liu, G. Pakulski, W. Jiang, M. Vachon, D. Poitras, and X. Zhang, “A quantum-dash dual-wavelength DFB laser for optical millimeter-wave radio-over-fiber systems,” Proc. Optical Fiber Communication Conference (OFC), 2021, pp. 1-3.
[17] Y. Mao, Z. G. Lu, J. R. Liu, P. J. Poole, and G.C. Liu, “Pulse Timing Jitter Estimated From Optical Phase Noise In Mode-lock Semiconductor Quantum Dash Lasers,” J. Lightwave Technol. 38(17), 4787-4793 (2020).
[18] Z. G. Lu, J.R. Liu, P.J. Poole, Y. X. Mao, J. Weber, G. Liu, and P. Barrio, “InAs/InP quantum dash semiconductor coherent comb lasers and their applications in optical networks,” J. Lightwave Technol., vol. 39, no. 12, pp. 3751-3760, 2021.
[19] Z. G. Lu, J. Liu, P.J. Poole, C. Song, and S. Chang, “Ultra-narrow linewidth quantum dot coherent comb lasers with self-injection feedback locking,” Opt. Express, vol. 26, no. 9, pp. 11909-11914, 2018.
[20] G. Liu, Z.G. Lu, J.R. Liu, Y.X. Mao, M. Vachon, C. Song, P. Barrios and P. J. Poole, “Passively mode-locked quantum dash laser with an aggregate 5.376 Tbit/s PAM-4 transmission capacity,” Opt. Express 28(4), 4587-4593 (2020).
[21] Z. G. Lu, J. R. Liu, S. Raymond, P. J. Poole, P. J. Barrios, D. Poitras, “312-fs-fs pulse generation from a passive C-band InAs/InP quantum dot mode-locked laser,” Opt. Express 16(14), 10835-10840 (2008).
[22] Z. G. Lu, J. R. Liu, P. J. Poole, S. Raymond, P. J. Barrios, D. Poitras, G. Pakulski, P. Grant, and D. Roy-Guay, “An L-band monolithic InAs/InP quantum dot mode-locked laser with femtosecond pulses,” Opt. Express 17(16), 13609-3614 (2009).
[23] Z. G. Lu, J. R. Liu, P. J. Poole, Z. J. Jiao, P. J. Barrios, D. Poitras, J. Caballero, and X. P. Zhang, “Ultra-high repetition rate InAs/InP quantum dot mode-mode locked lasers,” Opt. Commun. 284(9), 2323-2326 (2011).
[24] Z. G. Lu, J. R. Liu, C. Y. Song, J. Weber, Y. X. Mao, S. D. Chang, H. Ding, P. Poole, P. Barrios, and D. Poitras, “High Performance InAs/InP quantum dot 34.462-GHz C-band coherent laser module,” Opt. Express 26(2), 2160-2167 (2018).
[25] J.R. Liu, Z. G. Lu, S. Raymond, P.J. Poole, P. J. Barrios, and D. Poitras, “1.6-μm multiwavelength emission of an InAs/InGaAsP quantum dot laser,” IEEE Photonics Technology Letters, 20, No. 2, pp. 81-83 (January 2008).
[26] J.R. Liu, Z. G. Lu, S. Raymond, P.J. Poole, P.J. Barrios, G. Pakulski, D. Poitras, G. Z. Xiao, and Z. Y. Zhang, “Uniform 90-channel multiwavelength InAs/InGaAsP quantum dot laser,” Electron. Lett., 43, 8, 458-460 (April 2007).
[27] J.R. Liu, Z. G. Lu, S. Raymond, P. J. Poole, P. J. Barrios, D. Poitras, “Dual-wavelength 92.5 GHz self-mode-locked InP-based quantum dot laser,” Optics Letters, Vol. 33, No. 15, pp. 1702-1704 (August 2008).
[28] Z.J. Jiao, J.R. Liu, Z. G. Lu, X.P. Zhang, P.J. Poole, P.J. Barrios, D. Poitras, and J. Caballero, “Tunable Terahertz Beat Signal Generation from an InAs/InP Quantum-Dot Mode-Locked Laser Combined With External-Cavity,” IEEE Photonics Technol. Lett., vol. 24, No. 6, pp. 518-520, (March 2012).
[29] J.R. Liu, Z. G. Lu, P. J. Poole, P. J. Barrios, D. Poitras, Z. J. Jiao, and X. P. Zhang, “THz optical pulses from a coupled-cavity quantum-dot laser.” Optics Communications, Vol. 285, No. 6, pp. 1323-1325 (March 2012).
[30] M. Rahim, K. Zeb, Z.G. Lu, G. Pakulski, J.R. Liu, PJ. Poole, C.Y. Song, P.P. Barrios, W. H. Jiang, and X. P. Zhang, “Monolithic InAs/InP quantum dash dual-wavelength DFB laser with ultra-low noise common cavity modes for millimeter-wave applications”, Optics Express 27(24), 35368-35375 (November 25, 2019).
[31] Y. Mao, Jiaren Liu, Zhenguo Lu, Chunying Song and Philip Poole, “Ultra-Low Timing Jitter of Quantum Dash Semiconductor Comb Lasers with Self-Injection Feedback Locking”, IEEE Journal of Selected Topics in Quantum Electronics, Vol. 25, No. 6, 1900607(November/December 2019).
[32] Y. Chen, J. Li, P. Zhu, H. Peng, J. Zhu, Y. Tian, Z. Wu, D. Ge, P. Zhou, K. Liu, Y. Xu, J. Chen, Y. He, and Z. Chen, “Cost effective wavelength reused MDM system for bidirectional mobile fronthaul,” Opt. Express, vol. 24, no. 20, pp. 22413-22422, 2016.
[33] Q. Mo, J. He, D. Yu, L. Deng, S. Fu, M. Tang, and D. Liu, “2×2 MIMO OFDM/OQAM radio signals over an elliptical core few-mode fiber,” Opt. Lett., vol. 41, no. 19, pp. 4546-4549, 2016.
[34] Y. Chen, J. Li, H. Peng, P. Zhu, Y. Tian, Z. Wu, J. Zhu, D. Ge, P. Zhou, K. Liu, Y. Xu, J. Chen, Y. He, and Z. Chen, “Bidirectional mobile fronthaul based on wavelength reused MDM,” in Proc. 15^{th} Int. Conf. Opt. Commun. Netw. (ICOCN), Sep. 2016, pp. 1-3.
[35] N. P. Diamantopoulos, S. Inudo, Y. Yoshida, A. Maruta, A. Kanno, P. T. Dat, T. Kawanishi, R. Maruyama, N. Kuwaki, S. Matsuo, and K. Kitayama, “Mode-division multiplexed W-Band RoF transmission for higher-order spatial multiplexing,” in Proc. Opt. Fiber Commun. Conf. Exhib. (OFC), Mar. 2015, pp. 1-3.
[36] N. P. Diamantopoulos, Y. Takami, Y. Yoshida, A. Maruta, A. Kanno, N. Yamamoto, T. Kawanishi, R. Maruyama, N. Kuwaki, S. Matsuo, and K. Kitayama, “Mitigation of modal crosstalk-induced power fading in mode division crosstalk-induced power fading in mode division multiplexed W-band RoF links,” in Opt. Fiber Commun. Conf. Exhibit. (OFC), Mar. 2016, pp. 1-3.
[37] C. Xu, G. Gao, P. Deng, R. Wu, T. Jiang, Y. Shen, and J. Wang, “Experimental demonstration of analog transmission using mode division multiplexing,” in Proc. Opt. Fiber Commun. Conf., Mar. 2018, pp. 1-3.
[38] J. Du, D. Xie, C. Yang, and J. Wang, “Demonstration of analog links using spatial modes in km-scale few mode fiber,” Opt. Express, vol. 25, no. 4, pp. 3613-3620, 2017.
[39] X. Liang, W.-L. Li, W. A. Wood, J. D. Downie, J. E. Hurley, and A. Ng'oma, “Transmission of wireless signals using space division multiplexing in few mode fibers,” Opt. Express, vol. 26, no. 16, pp. 20507-20518, 2018.
[40] L. Combi, A. Matera, A. Gatto, P. Parolari, P. Boffi, and U. Spagnolini, “Radio-over-modes for C-RAN architecture with smart optical resources assignment,” in Proc. IEEE Int. Conf. Commun. (ICC), May 2017, pp. 1-6.
[41] H. Kuboki and M. Matsuura, “Modal dispersion and feed light crosstalk mitigations by using center-and offset-launching for optically-powered radio-over-multimode fiber systems,” in Proc. Opt. Fiber Commun. Conf., Mar. 2018, pp 1-3.
[42] G. S. D. Gordon, M. J. Crisp, R. V. Penty, T. D. Wilkinson, and I. H. White, “Feasibility demonstration of a mode-division multiplexed MIMO-enabled radio-over-fiber distributed antenna system,” J. Lightw. Technol., vol 32, no. 20, pp. 3521-3528, Oct. 15, 2014
[43] Y. Lei, J. Li, Z. Meng, R. Wu, Z. Wan, Y. Fan, W. Zhang, F. Yin, Y. Dai, and K. Xu, “Feasibility of Space-division-multiplexed transmission of IEEE 802.11 n/ac-compliant wireless MIMO signals over OM3 multimode fiber,” J. Lightw. Technol., vol 36, no. 11, pp. 2076-2082, Jun. 1, 2018.
[44] Y. Lei, J. Li, Y. Fan, D. Yu, S. Fu, F. Yin, Y. Dai, and K. Xu, “Space-division multiplexed transmission of 3×3 multiple-input multiple-output wireless signals over conventional graded-index multimode fiber,” Opt. Express, vol. 24, no.25, pp. 28372-28382, Dec. 2016.
[45] Y. Lei, J. Li, R. Wu, Y. Fan, S. Fu, F. Yin, Y. Dai, and K. Xu, “Experimental study on the statistic characteristics of a 3×3 RF MIMO channel over a single conventional multimode fiber,” Opt. Lett., vol. 42, no.11, pp. 2217-2220, 2017.
[46] A. Raza, S. Ghafoor, and M. F. U. Butt, “MIMO-enabled integrated MGDM WDM distributed antenna system architecture based on plastic optical fibers for millimeter-wave communication,” Photonic Netw. Commun., vol. 35, no. 2, pp. 265-273, Apr. 2018.
[47] L. A. Rusch, M. Rad, K. Allahverdyan, I. Fazal, and E. Bernier, “Carrying data on the orbital angular momentum of light,” IEEE Commmun. Mag., vol. 56, no. 2, pp. 219-224, Feb. 2018.
[48] M. Li, “On performance of optical wireless communication with spatial towards 5-G,” IEEE Access, vol. 6, pp. 28108-28113, 2018.
[49] R. M. Nejad, F. Tavakoli, L. Wang, X. Guan, S. LaRochelle, and L.A. Rusch, “Four-channel RoF transmission over polarization maintaining elliptical ring core fiber,” in Proc. Opt. Fiber Commun. Conf., Mar. 2018, pp. 1-3.
[50] R. M. Nejad, F. Tavakoli, L. Wang, X. Guan, S. LaRochelle, and L.A. Rusch, “RoF data transmission using four linearly polarized vector modes of a polarization maintaining elliptical ring core fiber,” J. Lightw. Technol., vol. 36., no. 17, pp. 3794-3801, Sep. 1, 2018.
[51] A. Macho, M. Morant, and R. Llorente, “Next-generation optical fronthaul systems using multicore fiber media,” J. Lightw. Technol., vol. 34, no. 20, pp. 4819-4827, Oct. 15, 2016.
[52] J. He, B. Li, L. Deng, M. Tang, L. Gan, S. Fu, P.P. Shum, and D. Liu, “Experimental demonstration of bidirectional OFDM/OQAM-MIMO signal over multicore fiber system,” IEEE Photon. J., vol. 8, no. 5, Oct. 2016, Art. no. 7906808.
[53] J. M. Galve, I. Gasulla, S. Sales, and J. Capmany, “Reconfigurable radio access networks using multicore fibers,” IEEE J. Quantum Electron., vol 52, no. 1, Jan. 2016, Art. no. 0600507.
[54] J. M. Galve, I. Gasulla, S. Sales, and J. Capmany, “Fronthaul design for radio access networks using multicore fibers,” Waves Magaz, vol. 7, no. 1, pp. 69-80, 2015.
[55] M. Morant, and R. Llorente, “Performance analysis of multiple radioaccess provision in a multicore-fibre optical fronthaul,” Opt. Commun., vol 436, pp 161-167, Apr. 2019.
[56] A. Macho, M. Morant, and R. Llorente, “Impact of inter-core crosstalk in radio-over-fiber transmission on multi-core optical media,” in Proc. SPIE Broadband Access Commun. Technol. X, Feb. 2016, Paper 977200.
[57] A. Macho, M. Morant, and R. Llorente, “Experimental evaluation of nonlinear crosstalk in radio-over-fiber transmission on multi-core optical fiber,” Opt. Express, vol. 23, no. 14, pp. 18712-18720, 2015.
[58] M. Morant, and R. Llorente, “Performance analysis of carrier-aggregated multiantenna 4×4 MIMO LTE-A fronthaul by spatial multiplexing on multicore fiber,” J. Lightw. Technol., vol. 36, no. 2, pp. 594-600, Jan. 15, 2018.
[59] R. Llorente and M. Morant, “Bidirectional MIMO and SISO 3GPP LTE advanced fronthaul architectures based on multicore fiber,” in Proc. SPIE Broadband Access Commun. Technol. XI, Jan. 2017, Paper 101280D
[60] M. Morant, A. Macho, and R. Llorente, “On the suitability of multicore fiber for LTE-advanced MIMO optical fronthaul systems,” J. Lightw. Technol., vol. 34, no. 2, pp. 676-682, Jan. 15, 2016
[61] C. Liu, L. Deng, J. He, D. Li, S. Fu, M. Tang, M. Cheng, and D. Liu, “Experimental demonstration of high spectral efficient 4×4 MIMO SCMA-OFDM/OQAM radio over multi-core fiber system,” Opt. Express vol. 25, no. 15, pp. 18431-18441, 2017.
[62] M. Morant and R. Llorente, “Reconfigurable radio-over-multicore optical fronthaul for seamless 2G, UMTS and LTE-A MIMO wireless provision,” in Proc. Opt. Fiber Commun. Conf., Mar. 2017, pp. 1-3.
[63] T. Umezawa, P.T. Dat, K. Khasima, A. Kanno, N. Yamamoto, and T. Kawanishi, “100-GHz radio and power over fiber transmission through multicore fiber using optical-to-radio Converter,” Lightw. Technol., vol. 36, no. 2, pp. 617-623, Jan. 15, 2018.
[64] I.A. Alimi, A. L. Teixeira, and P.P. Monteiro, “Toward an efficient C-RAN optical fronthaul for future networks: A tutorial on technologies, requirements, challenges, and solutions,” IEEE Commun. Surveys Tuts., vol. 20, no. 1, pp. 708-769, 1st Quart., 2018.
[65] R. Muñoz, S. Rommel, P. V. Dijk, J. Brenes, E. Grivas, C. Manso, C. Roeloffzen, R. Vilalta, J. M. Fabrega, G. Landi, R. Casellas, R. Martínez, and I. T. Monroy, “Experimental Demonstration of Dynamic Optical Beamforming for Beyond 5G Spatially Multiplexed Fronthaul Networks,” IEEE Journal of Selected Topics in Quantum Electronics, vol. 27, no. 6, pp. 1-16, Nov.-Dec. 2021, Art no. 8600216, doi: 10.1109/JSTQE.2021.3079726.
[66] M. Sung, J. Kim, E.-S. Kim, S.-H. Cho, Y.-J. Won, B.-C. Lim, S.-Y. Pyun, H. Lee, J. K. Lee, and J. H. Lee, “RoF-based radio access network for 5G mobile communication systems in 28 GHz millimeter-wave,” J. Lightw. Technol., vol. 38, no. 2, pp. 409-420, Jan. 2020.
[67] M. Sung, S. Cho, J. Kim, J. K. Lee, J. H. Lee, and H. S. Chung, “Demonstration of IFoF-based mobile fronthaul in 5G prototype with 28-GHz millimeter wave,” J. Lightw. Technol., vol. 36, no. 2, pp. 601-609, Jan. 2018.
[68] P. T. Dat, A. Kanno, N. Yamamoto, and T. Kawanishi, “Radio-over-fiberbased seamless fiber-wireless convergence for small cell and linear cell networks,” in Proc. Opt. Fiber Commun. Conf., Mar. 2018, pp 1-3.

1. A method for millimeter-wave (MMW) wireless communications, the method comprising the steps of:
at a central office,
with a single quantum dot multi-wavelength laser (QD MWL) source, generating at least one optical signal comprising a plurality of different frequency signals;
splitting the at least one optical signal into at least one first split signal and at least one second split signal;
modulating the at least one first split signal with at least one wireless data signal by at least one optical modulator and generating at least one downlink optical data signal, wherein the at least one frequency signal of the first split optical signal of the QD-MWL is used as an optical local oscillator (LO) for synthesizing RF MMW wireless signals remotely by mixing with the at least one downlink optical data signal; and
transmitting the at least one downlink optical data signal and the optical LO over an optical transmission medium to at least one remote radio head or remote radio unit (RRH/RRU); and
the at least second split signal of the QD-MWL is used as an optical LO for the receiving uplink wireless signals at the central office.

2. The method of claim 1, further comprising the step of:
at a first wavelength selective switch, receiving the at least one first split optical signal and selecting from a plurality of frequency channels at least one data channel and at least one optical local oscillator (LO) channel, wherein each of the channels comprises signals at different wavelengths.

3. The method of claim 2, further comprising the step of selecting a frequency spacing between a first wavelength of the at least one data channel and a second wavelength of the at least one optical local oscillator (LO) channel.

4. The method of claim 3, wherein the at least one data channel is used for downlink wireless data transmission to the at least one RRH/RHU and at least one optical local oscillator (LO) channel is used for heterodyne RF MMW signal generation and uplink signal modulation at the at least one RRH/RRU.

5. The method of claim 4, wherein the at least one data channel is modulated with a wireless data signal.

6. The method of claim 5, comprising a further step of multiplexing the at least one modulated data channel and the at least one optical local oscillator (LO) channel to generate at least one downlink optical signal.

7. The method of claim 6, wherein the step of multiplexing comprises at least one of the wavelength division multiplexing (WDM) and space division multiplexing (SDM) through mode division multiplexing (MDM) or combination of them where plurality of optical frequency individual or WDM multiplexed signals including wireless data signals and optical local oscillators (LOs) for remote up/down-conversion to/from MMW signals are transported in at least one of a plurality of WDM channels or spatial modes of the optical SDM link in both directions.

8. The method of claim 7, wherein the optical transmission medium is an optical fiber, with standard single mode fiber (SSFM) or SDM fiber.

9. The method of claim 8, further comprising the steps of:
at the at least one RRH/RRU,
amplifying the received at least one downlink signal;
demultiplexing the at least one optical modulated data channel and the at least one optical local oscillator (LO) channel from the at least one downlink optical multiplexed signal comprising of a plurality of optical channels;
beating the at least one modulated data channel and the at least one optical local oscillator channel on at least one first photodetector to generate at least one radio frequency (RF) MMW wireless signal; and
receiving at least one RF MMW wireless signal at an antenna element of a phased array antenna (PAA) or individual antenna associated with a cell and amplifying the at least one RF MWW wireless received signal.

10. The method of claim 9, wherein the cell is at least one of a microcell, a picocell, and a femtocell.

11. The method of claim 10, wherein the at least one modulated data channel and the at least one optical local oscillator (LO) channel undergo optical beamforming (OBF) before the heterodyne mixing step through a remote optical beamforming network (OBFN) to adjust the relative amplitude and time delay or phase of the signals in accordance with the intended shape and direction of the MMW wireless beam at the phased array antenna (PAA).

12. The method of claim 11, wherein the at least one RRH/RRU comprises the PAA supportive of MMW M×M MIMO wireless signals.

13. The method of claim 11, wherein the at least one wireless signal generated or received at the RRH/RRU is found in at least one of a K-band, Ka-band, U-band, V-band, W-band, D-band or other higher frequency bands including standard 3GPP 5G new radio bands and even in the THz frequency range.

14. The method of claim 12, further comprising the steps of:
at the at least one RRH/RRU, receiving at least one uplink RF MMW wireless signal for transmission;
amplifying the received at least one uplink RF MMW wireless signal;
selecting at least one optical carrier channel from the at least one of the plurality of optical local oscillator (LO) signals for transporting the at least one uplink RF MMW wireless signal;
performing optical modulation of the at least one selected optical carrier channel with the at least one amplified uplink RF MMW wireless signal;
multiplexing the uplink modulated optical signals to generate at least one uplink optical signal; and
transmitting the at least one uplink optical signal over the optical transmission medium to the central office.

15. The method of claim 14, further comprising the step of, at the central office, demultiplexing the at least one uplink optical signal into a plurality of optical channels.

16. The method of claim 15, further comprising the step of, from the at least second split optical signal of the QD-MWL, selecting a plurality of optical local oscillators (LOs) at a wave selective switch.

17. The method of claim 16, further comprising the step of, mixing the at least one uplink optical modulated data channel and the at least one optical local oscillator (LO) channel in photonic down conversion module (PDC) on at least one photodetector to generate a lower frequency band signal or a receiving wireless beam signal;
performing receiving optical beamforming (OBF) with at least one optical beamforming network (OBFN), adjusting the relative time delay or phase and amplitude of the signals and constructing the receiving beam in the direction of the receiving wireless signals.

18. The method of claim 17, further comprising the step of processing the lower frequency band signal in a DSP module.

19. The method of claim 18, wherein the optical carriers for the uplink signals at the at least one RRH/RRU is derived from the same single QD MWL laser source at the central office.

20. A millimeter-wave (MMW) wireless communication system comprising:
a central office comprising a single QD-MWL source for generating MMW wireless signals remotely;
an optical coupler for splitting at least one optical signal into at least one first split signal comprising of multiple wavelengths for use as at least one data channel and at least one one optical local oscillator (LO);
a first optical modulator for modulating the least one first split signal with at least one wireless data signal and combining the at least one data modulated optical signal with at least one optical LO generating one downlink optical MMW signal;
an optical transmission medium; and
at least one remote radio head or remote radio unit (RRH/RRU) for receiving at least one downlink wireless data signal, and at least one optical LO for up-converting the received at least one downlink data signal into at least one RF MMW wireless signal; and
wherein the same at least one optical LO at the central office is reused to provide at least one optical carrier and at least one optical LO to the least one uplink and downlink MMW wireless signals, respectively, at the at least one RRH/RRU where the at least one uplink MMW wireless signal modulates the at least one optical carrier in a single side band (SSB) or carrier-suppressed single-sideband modulation (CS-SSB) configuration, and whereby the at least one uplink MMW signal is transported via the optical transmission medium to the central office, achieving RF synthesizer free RRH/RRU; and
wherein the at least one RF MMW signal received at the central office is optically down-converted to at least one intermediate frequency (IF) or baseband signal by the at least one optical channel of the same QD-MWL or down-converted electronically depending on the system requirements and the at least one IF/baseband signal is converted to digital signal for baseband digital signal processing.

21. The system of claim 20, wherein the electrical to optical and optical to electrical conversion system is associated with a central office.

22. The system of claim 21, wherein the central office comprises a transceiver.

23. The system of claim 20, wherein the optical to electrical and electrical to optical conversion system is associated with the at least one RRH/RRU.

24. The system of claim 23, wherein the at least one RRH/RRU comprises a transceiver.

25. The system of claim 20, wherein the wireless signal comprises a frequency in at least one of a K-band, Ka-band, U-band, V-band, W-band, D-band, or other higher bands including the standard 3GPP 5G new radio bands (24.25 GHz-71 GHz) and even frequency band in the THz range.

26. The system of claim 20, wherein the system realizes single input single output (SISO) and/or massive multiple input multiple output (M-MIMO) and/or optical beamforming (OBF) operations by employing N×M phased array antenna (PAA) through wavelength division multiplexing (WDM) and spatial division multiplexing (SDM).
